(19) United States
(12) Patent Application Publication
(10) Pub. No.: US 2014/0112703 A1
(43) Pub. Date: Apr. 24, 2014

(54) ADJUSTABLE SEAT TUBING DEVICE FOR A BICYCLE

(71) Applicant: Chao-Hu Chen, Taichung City (TW)

(72) Inventor: Chao-Hu Chen, Taichung City (TW)

(21) Appl. No.: 13/655,389

(22) Filed: Oct. 18, 2012

(51) Int. Cl. B62J 1/08; B62K 19/36

(52) U.S. Cl. 403/109.2

(57) ABSTRACT

An adjustable seat tubing device for a bicycle includes a tubing assembly, an adjusting unit and a controlling assembly, the tubing assembly including an outer tubing and an inner tubing, the outer tubing assembled to a bicycle, the inner tubing passing through the outer tubing, the adjusting unit assembled within the tubing assembly, the controlling assembly comprising a switch and an actuating member assembled to the switch and the adjusting unit. Under this arrangement, when a user presses the switch, the inner tubing is movable relative to the outer tubing, so that a height of the tubing assembly is adjustable to the user for riding bicycle comfortably.

### BACKGROUND OF THE INVENTION

1. Field of the Invention

The present invention relates to a seat tubing device, and more particularly to an adjustable seat tubing device for a bicycle.

2. Description of Related Art

Bicycle activity is more and more popular in these days because bicycle activity is eco-friendly, convenient and entertaining. Many enterprises encourage their employees to go to work by bicycles instead of driving vehicles today. Many people also go shopping or go traveling by bicycles during their leisure time. Because a height-adjustable seat tubing device is very important for the comfort of riding, the improvement of the height-adjustable seat tubing device is continuously progressed.

A conventional seat tubing device comprises a first post tubing, a second post tubing and a protruded member. The first post tubing is inserted into the second post tubing. A plurality of first through holes is opened along a length of the first post tubing. A plurality of second through holes is opened along another length of the second post tubing. The first through holes correspond to the second through, hole respectively. The protruded member is insertable into the second through holes and the first through holes in order. Under this arrangement, a height of the conventional seat post tubing is adjustable because of the engagement between the protruded member and said through holes.

However, the conventional seat tubing device has disadvantages as following.

Firstly, the number of said through holes are limited so that a user cannot freely adjust the height of the conventional seat post tubing.

Second, under a long term use, both the protruded member and said through holes suffer abrasion so that the protruded member cannot engage with said through holes well.

The present invention has arisen to mitigate and/or obviate the disadvantages of the conventional.

### SUMMARY OF THE INVENTION

The main objective of the present invention is to provide an adjustable seat tubing device for a bicycle.

To achieve the objective, an adjustable seat tubing device for a bicycle comprises a tubing assembly, an adjusting unit and a controlling assembly, the tubing assembly comprising an outer tubing, an inner tubing and a connecting member, the outer tubing assembled to a bicycle, the inner tubing passing through the outer tubing, the connecting member sleevingly defined between the outer tubing and the inner tubing, the connecting member having an outer connecting portion defined at an outer periphery thereof, the outer connecting portion communicating with the tubing assembly, the adjusting unit comprising a pivoting assembly, a driving assembly, an engaging assembly and an elastomer, the pivoting assembly pivotally assembled into the outer connecting portion, the driving assembly assembled into the tubing assembly, the driving assembly comprising a supporting member and a flapping member, the flapping member pivotally assembled into the supporting member, the flapping member having a pushing portion defined at one end thereof and a working portion defined at another end thereof, the working portion passing through the supporting member, the engaging assembly comprising a gear rack and an engaging block, the gear rack assembled into the inner tubing, the gear rack having a plurality of rack teeth defined at one side thereof, one side of the engaging block pivotally assembled to the supporting member, and another side of the engaging block having a plurality of engaging teeth, the engaging teeth engaging with the rack teeth of the gear rack, the pushing portion slidably assembled to the engaging block, the elastomer defined in the outer tubing, the elastomer enclosing the driving assembly, two ends of the elastomer abutting against the inner tubing and the outer tubing respectively, the controlling assembly comprising a switch and an actuating member, one end of the actuating member assembled to the switch, and another end of the actuating member pivotally passing through the pivoting assembly and assembled to the working portion inside the outer tubing, the actuating member driving the pivoting assembly rotating simultaneously. Wherein, the pivoting assembly comprises a pivoting block and a rod; the pivoting block is pivotally assembled into the outer connecting portion; the pivoting block has an abutting portion and a cave groove defined thereon; the abutting portion is abuttable against the connecting member; the cave groove is opposite to the outer connecting portion; the rod is received in the cave groove; wherein the actuating member passes through the outer connecting portion, the pivoting block and the cave groove firstly; then, the actuating member further passes through the rod and the abutting portion in the outer tubing; finally, the actuating member is assembled to the working portion of the driving assembly; the outer tubing has a connecting hole opened thereon; an abutting block is assembled into the working portion; the actuating member is inserted into the working portion and is assembled to the abutting block; a base is defined in the outer tubing; the base has a fastening groove opened thereof; the base has an opening defined thereon; the opening corresponds to a lateral side of the fastening groove so that the opening communicates with the fastening groove; the driving assembly is inserted into the fastening groove; the working portion of the flapping member corresponds to the opening; one end of the elastomer is abutted against the inner tubing, and another end of the elastomer is abutted against the base; a fastening ring is assembled to the switch so that the fastening ring is mountable on a handlebar of the bicycle; the inner tubing has a plurality of limiting blocks defined on an outer wall thereof; the outer tubing has a plurality of limiting grooves recessed on an inner wall thereof; the limiting blocks engage with the limiting grooves respectively. Under this arrangement, when a user presses the switch, the switch drives the actuating member firstly; then, the actuating member drives the flapping member; and then, the flapping member drives the engaging block disengaging with the gear rack; as a result, the inner tubing is movable relative to the outer tubing, so that a height of the tubing assembly is adjustable to the user for riding bicycle comfortably.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an adjustable tubing device for a bicycle of the present invention;

FIG. 2 is an exploded perspective view of the adjustable tubing device for a bicycle;

FIG. 2A is a perspective view of an engaging block of the adjustable tubing device for a bicycle;

FIG. 3 is a perspective view of a pivoting assembly of the adjustable tubing device for a bicycle;

FIG. 4 is a cross-sectional view of the adjustable tubing device for a bicycle;

FIG. 5 is a cross-sectional view for showing a tubing assembly is adjustable when a controlling assembly of the present invention is pressed; and

FIG. 6 is a schematic view for showing the present invention is assembled on a bicycle.

### DETAILED DESCRIPTION OF THE INVENTION

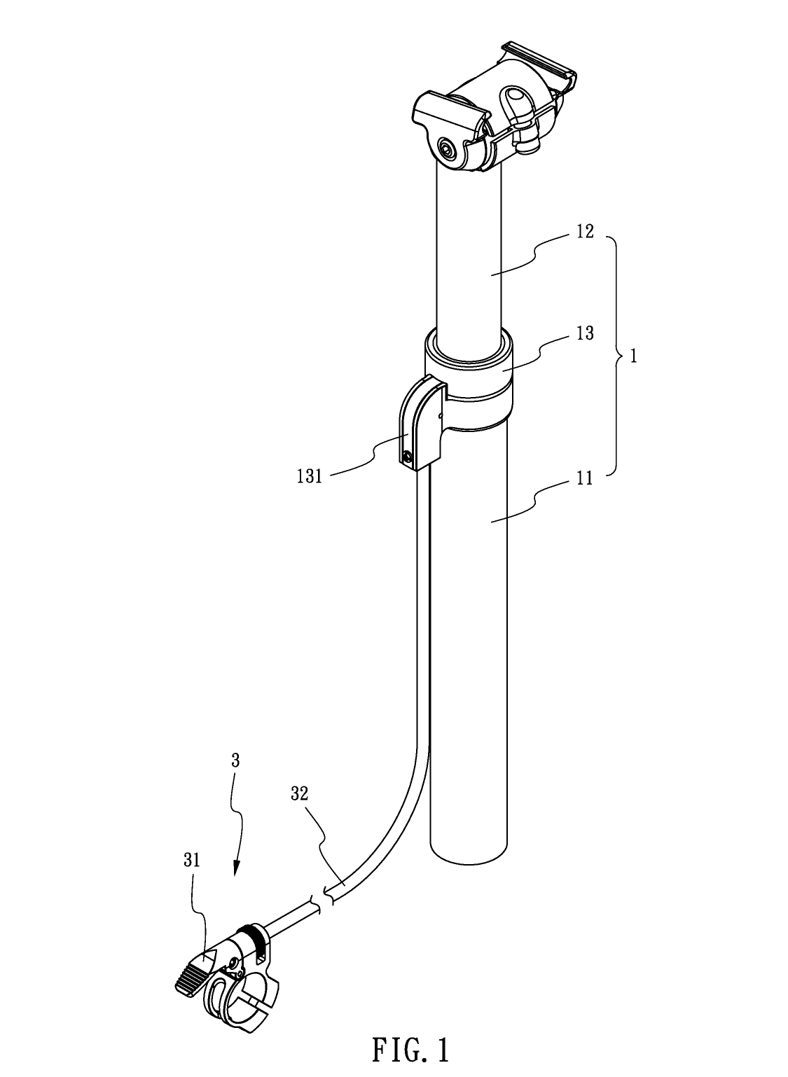

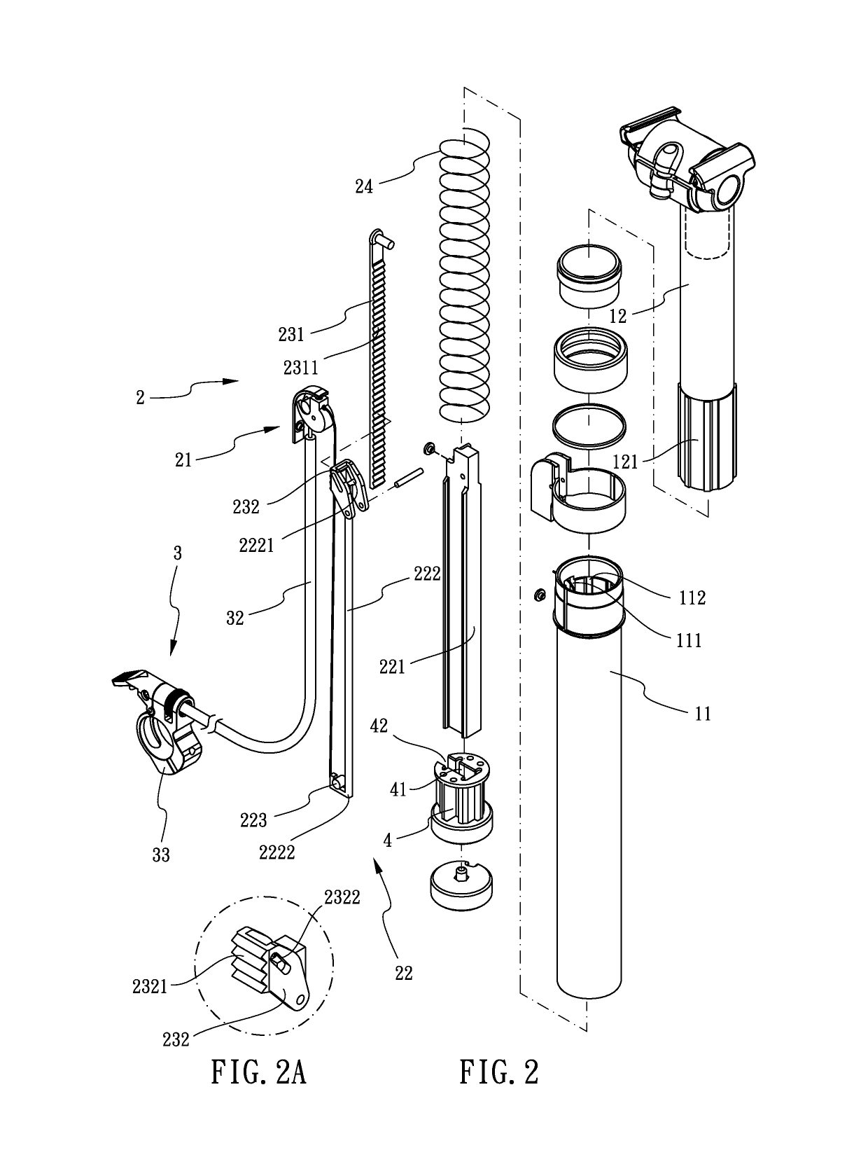

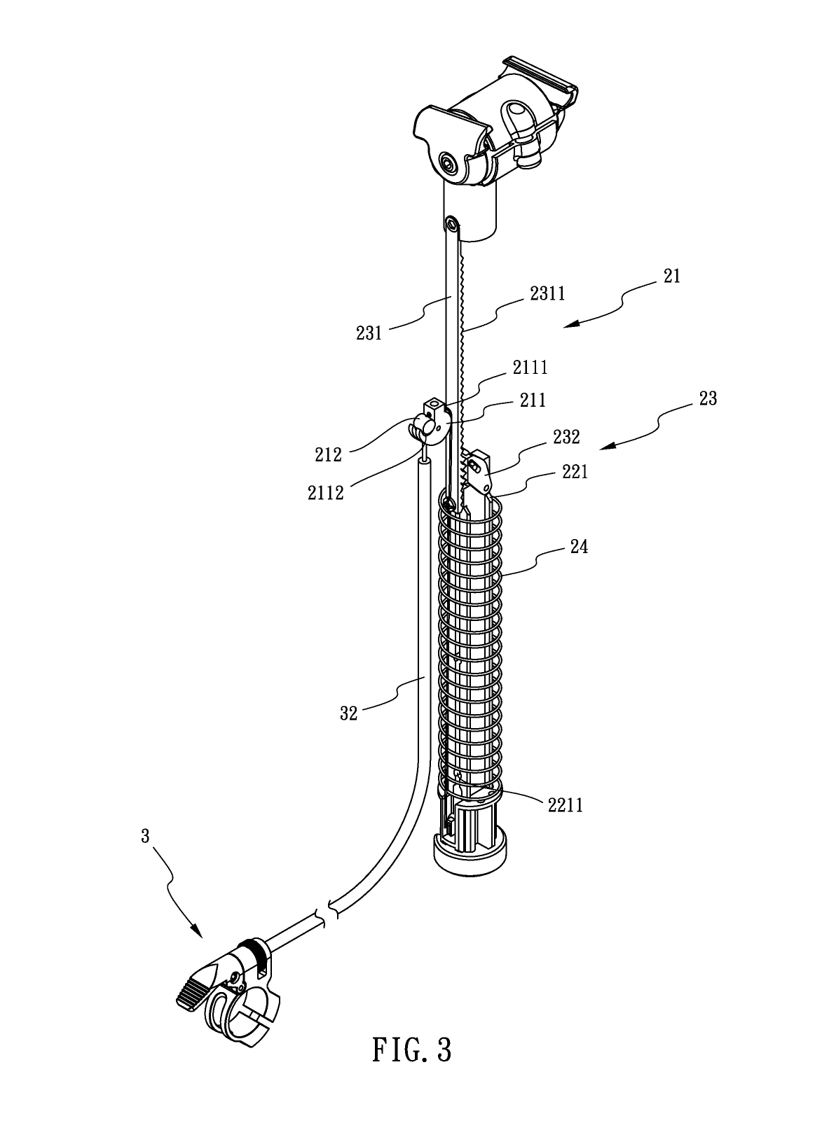

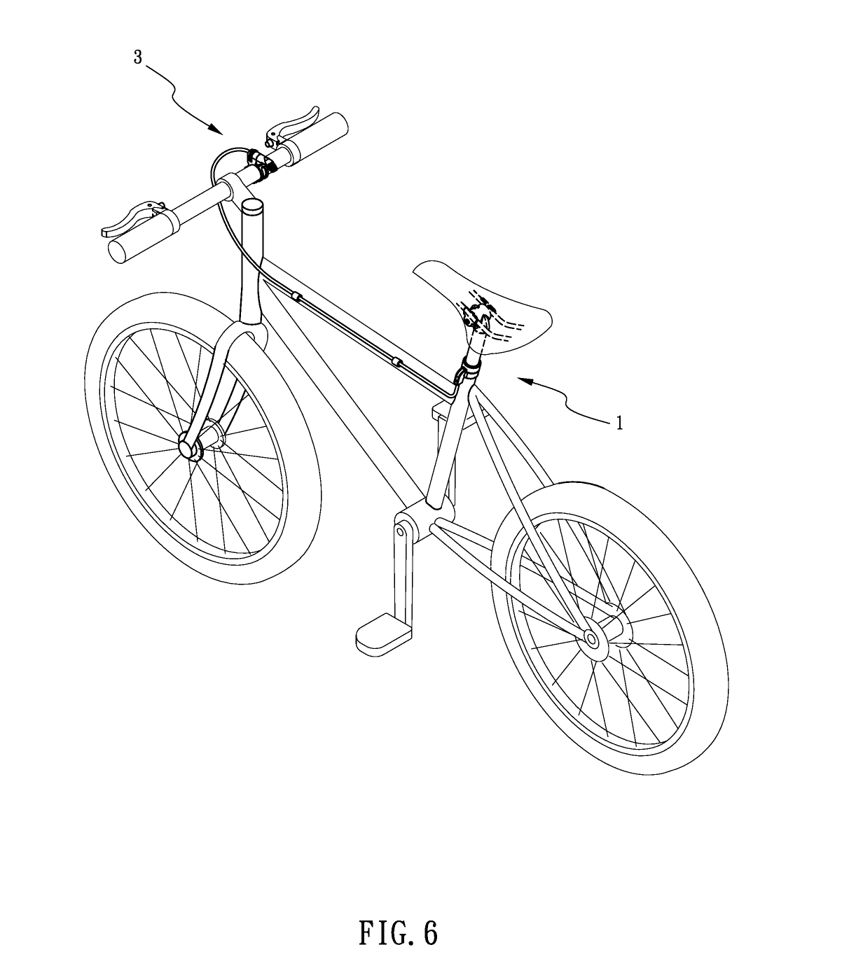

Referring to FIGS. 1-6, an adjustable tubing device for a bicycle in accordance with the present invention comprises a tubing assembly 1, an adjusting unit 2 and a controlling assembly 3.

The tubing assembly 1 comprises an outer tubing 11, an inner tubing 12 and a connecting member 13. The outer tubing 11 is assembled to a bicycle (not numbered). The inner tubing 12 passes through the outer tubing 11. The connecting member 13 is sleevingly defined between the outer tubing 11 and the inner tubing 12. The connecting member 13 has an outer connecting portion 131 defined at an outer periphery thereof. The outer connecting portion 131 communicates with the tubing assembly 1.

The adjusting unit 2 comprises a pivoting assembly 21, a driving assembly 22, an engaging assembly 23 and an elastomer 24.

The pivoting assembly 21 is pivotally assembled into the outer connecting portion 131.

The driving assembly 22 is assembled into the tubing assembly 1. The driving assembly 22 comprises a supporting member 221 and a flapping member 222. The flapping member 222 is pivotally assembled into the supporting member 221. The flapping member 222 has a pushing portion 2221 defined at one end thereof and a working portion 2222 defined at another end thereof. The working portion 2222 passes through the supporting member 221.

The engaging assembly 23 comprises a gear rack 231 and an engaging block 232. The gear rack 231 is assembled into the inner tubing 12. The gear rack 231 has a plurality of rack teeth 2311 defined at one side thereof. One side of the engaging block 232 is pivotally assembled to the supporting member 221, and another side of the engaging block 232 has a plurality of engaging teeth 2321. The engaging teeth 2321 engage with the rack teeth 2311 of the gear rack 231. The pushing portion 2221 is slidably assembled to the engaging block 232.

The elastomer 24 is defined in the outer tubing 11. The elastomer 24 encloses the driving assembly 22. Two ends of the elastomer 24 abut against the inner tubing 12 and the outer tubing 11 respectively.

The controlling assembly 3 comprises a switch 31 and an actuating member 32 (In the present invention, the actuating member 32 is a cable and a protecting tubing which encloses the cable.). One end of the actuating member 32 is assembled to the switch 31, and another end of the actuating member 32 pivotally passes through the pivoting assembly 21 and assembles to the working portion 2222 inside the outer tubing 11. The actuating member 32 drives the rotation of the pivoting assembly 21 rotating simultaneously.

Under this arrangement, when a user presses the switch 31, the switch 31 drives the actuating member 32 firstly; then, the actuating member 32 drives the flapping member 222; and then, the flapping member 222 drives the engaging block 232 disengaging with the gear rack 231 by a flapping motion; as a result, the inner tubing 12 is movable relative to the outer tubing 11. Therefore, a height of the tubing assembly 1 is adjustable to the user for riding bicycle comfortably.

Referring to FIGS. 1-6, the further details of the present invention are shown as following:

1. The pivoting assembly 21 comprises a pivoting block 211 and a rod 212. The pivoting block 211 is pivotally assembled into the outer connecting portion 131. The pivoting block 211 has an abutting portion 2111 and a cave groove 2112 defined thereon. The abutting portion 2111 is abuttable against the connecting member 13. The cave groove 2112 is opposite to the outer connecting portion 131. The rod 212 is received in the cave groove 2112. The actuating member 32 passes through the outer connecting portion 131, the pivoting block 211 and the cave groove 2112 firstly; then, the actuating member 32 further passes through the rod 212 and the abutting portion 2111 in the outer tubing 11; finally, the actuating member 32 is assembled to the working portion 2222 of the driving assembly 22.

2. The outer tubing 11 has a connecting hole 111 opened thereon. The connecting hole 111 corresponds to the pivoting block 211. The pivoting block 211 is partially involved in the connecting hole 111 so that a rotating angle of the pivoting block 211 relative to the rod 212 of the pivoting assembly 21 is increased.

3. The engaging block 232 has an assembling portion 2322 defined thereon. The assembling portion 2322 is a rail structure. The pushing portion 2221 of the flapping member 222 is slidably received in the assembling portion 2322. Under this arrangement, when the pushing portion 2221 of the flapping member 222 abuts an inner wall of the assembling portion 2322 of the engaging block 232 so as to drive the engaging block 232 pivotally rotated relative to the supporting member 221, the pushing portion 2221 is movable in the assembling portion 2322.

4. The working portion 2222 of the flapping member 222 is formed as groove-shaped. An abutting block 223 is assembled into the working portion 2222. The actuating member 32 is inserted into the working portion 2222 and is assembled to the abutting block 223.

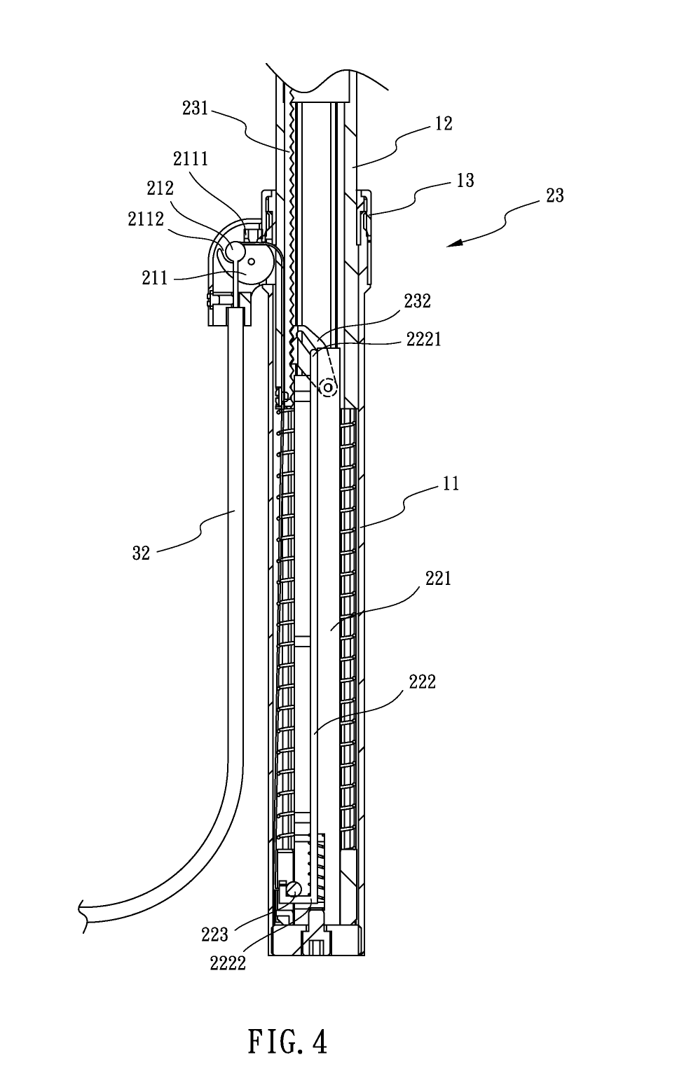

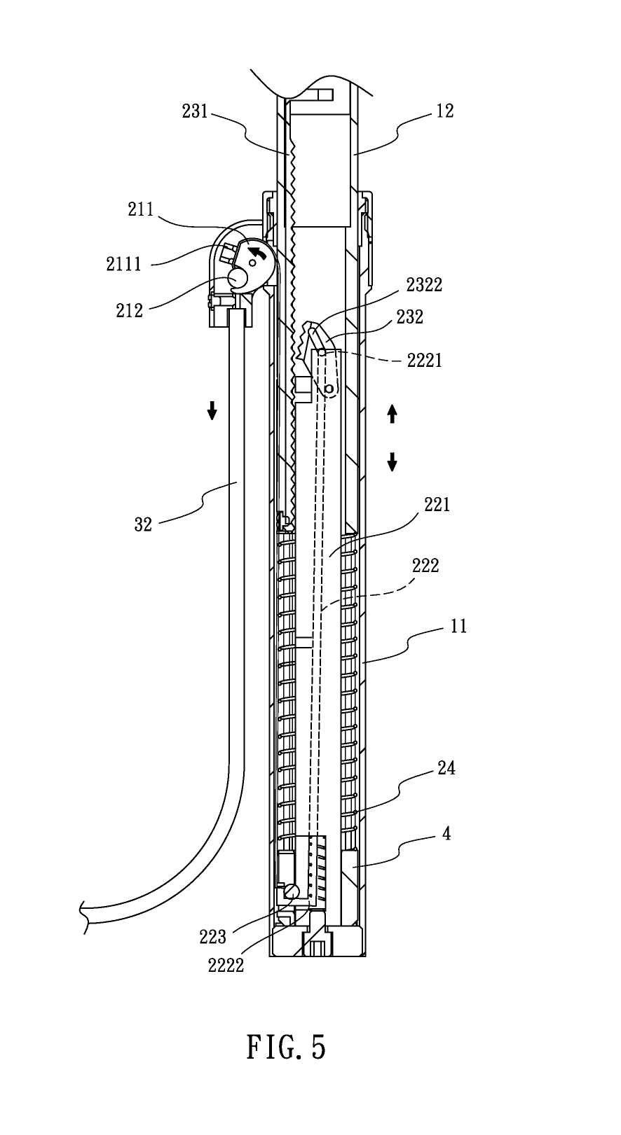

Referring to FIG. 1, FIG. 4 and FIG. 5, a process of adjusting the height of the tubing assembly 1 is described as following.

The user presses the switch 31 firstly; then, the switch 31 drives the actuating member 32 moving toward the switch 31 so as to drive the rod 212 abutting against the pivoting block 211 along a wall of the cave groove 2112; thereby, the pivoting block 211 is pivotally rotated counterclockwise so that the abutting portion 2111 of the pivoting block 211 is departed from the connecting member 13 and the abutting block 223 is abutted toward the pivoting assembly 21; thereby, the working portion 2222 of the flapping member 222 is pivotally rotated toward the pivoting block 211 while the pushing portion 2221 of the flapping member 222 is pivotally rotated toward an opposite side of the gear rack 231 so as to drive the engaging block 232 disengaging with the gear rack 231. Therefore, the inner tubing 12 is movable relative to the outer tubing 11 so as to adjust the height of the tubing assembly 1.

When the inner tubing 12 is pressed down by the user to reduce the height of the tubing assembly 1, the elastomer 24 is abutted against a bottom of the inner tubing 12 so that the elastomer 24 is compressed; when the user wants to elongate the height of the tubing assembly 1, the user presses the switch 31 such that the gear rack 231 is disengaged with the engaging block 232, and the elastomer 24 is restored by a restoring force so as to push the inner tubing 12 moving upwardly so that the height of the tubing assembly 1 is elongated.

The present invention further comprises a base 4. The base 4 is defined in the outer tubing 11. The base 4 has a fastening groove 41 opened thereof. The base 4 has an opening 42 defined thereon. The opening 42 corresponds to a lateral side of the fastening groove 41 so that the opening 42 communicates with the fastening groove 41. The driving assembly 22 is inserted into the fastening groove 41. The working portion 2222 of the flapping member 222 corresponds to the opening 42. One end of the elastomer 24 is abutted against the inner tubing 12, and another end of the elastomer 24 is abutted against the base 4. Under this arrangement, the driving assembly 22 is not rotated relative to the tubing assembly 1. In addition, the user assembles the driving assembly 22 to the base 4 easily because of the fastening groove 41 and the opening 42.

The present invention further comprises a fastening ring 33. The fastening ring 33 is assembled to the switch 31, thus the fastening ring 33 is mountable on a handlebar (not numbered) of the bicycle.

The inner tubing 12 further has a plurality of limiting blocks 121 defined on an outer wall thereof. The outer tubing 11 has a plurality of limiting grooves 112 recessed on an inner wall thereof. The limiting blocks 121 engage with the limiting grooves 112 respectively. One width of one limiting block 121 is bigger than another width of another limiting block 121. Under this arrangement, when the inner tubing 12 is inserted into the outer tubing 11, the inner tubing 12 is not rotated relative to the outer tubing 11.

All in all, the present invention has following advantages.

1. The user could adjust the height of the tubing assembly 1 even when the user rides on the bicycle.

2. The height of the tubing assembly 1 can be fine tuned because of the gear rack 231 and the engaging block 232.

3. The structure of the present invention is simple, so that both the repair and the maintenance are easy.

Although the invention has been explained in relation to its preferred embodiment, it is to be understood that many other possible modifications and variations can be made without departing from the spirit and scope of the invention as hereinafter claimed.

What is claimed is:

1. An adjustable seat tubing device for a bicycle comprising:
a tubing assembly, an adjusting unit and a controlling assembly;
the tubing assembly comprising an outer tubing, an inner tubing and a connecting member, the outer tubing assembled to a bicycle, the inner tubing passing through the outer tubing, the connecting member sleevingly defined between the outer tubing and the inner tubing, the connecting member having an outer connecting portion defined at an outer periphery thereof, the outer connecting portion communicating with the tubing assembly;
the adjusting unit comprising a pivoting assembly, a driving assembly, an engaging assembly and an elastomer;
the pivoting assembly pivotally assembled into the outer connecting portion;
the driving assembly assembled into the tubing assembly, the driving assembly comprising a supporting member and a flapping member, the flapping member pivotally assembled into the supporting member, the flapping member having a pushing portion defined at one end thereof and a working portion defined at another end thereof, the working portion passing through the supporting member;
the engaging assembly comprising a gear rack and an engaging block, the gear rack assembled into the inner tubing, the gear rack having a plurality of rack teeth defined at one side thereof, one side of the engaging block pivotally assembled to the supporting member, and another side of the engaging block having a plurality of engaging teeth, the engaging teeth engaging with the rack teeth of the gear rack, the pushing portion slidably assembled to the engaging block;
the elastomer defined in the outer tubing, the elastomer enclosing the driving assembly, two ends of the elastomer abutting against the inner tubing and the outer tubing respectively; and
the controlling assembly comprising a switch and an actuating member, one end of the actuating member assembled to the switch, and another end of the actuating member pivotally passing through the pivoting assembly and assembled to the working portion inside the outer tubing, the actuating member driving the pivoting assembly rotating simultaneously;
wherein when a user presses the switch, the switch drives the actuating member firstly; then, the actuating member drives the flapping member; and then, the flapping member drives the engaging block disengaging with the gear rack; as a result, the inner tubing is movable relative to the outer tubing, so that a height of the tubing assembly is adjustable to the user for riding bicycle comfortably.

2. The adjustable seat tubing device for a bicycle as claimed in claim 1, wherein the pivoting assembly comprises a pivoting block and a rod; the pivoting block is pivotally assembled into the outer connecting portion; the pivoting block has an abutting portion and a cave groove defined thereon; the abutting portion is abuttable against the connecting member; the cave groove is opposite to the outer connecting portion; the rod is received in the cave groove; wherein the actuating member passes through the outer connecting portion, the pivoting block and the cave groove firstly; then, the actuating member further passes through the rod and the abutting portion in the outer tubing; finally, the actuating member is assembled to the working portion of the driving assembly.

3. The adjustable seat tubing device for a bicycle as claimed in claim 2, wherein the outer tubing has a connecting hole opened thereon.

4. The adjustable seat tubing device for a bicycle as claimed in claim 1, wherein an abutting block is assembled into the working portion; the actuating member is inserted into the working portion and is assembled to the abutting block.

5. The adjustable seat tubing device for a bicycle as claimed in claim 1, wherein a base is defined in the outer tubing; the base has a fastening groove opened thereof; the base has an opening defined thereon; the opening corresponds to a lateral side of the fastening groove so that the opening communicates with the fastening groove; the driving assembly is inserted into the fastening groove; the working portion of the flapping member corresponds to the opening; one end of the elastomer is abutted against the inner tubing, and another end of the elastomer is abutted against the base.

6. The adjustable seat tubing device for a bicycle as claimed in claim 1, wherein a fastening ring is assembled to the switch so that the fastening ring is mountable on a handlebar of the bicycle.

7. The adjustable seat tubing device for a bicycle as claimed in claim 1, wherein the inner tubing has a plurality of limiting blocks defined on an outer wall thereof; the outer tubing has a plurality of limiting grooves recessed on an inner wall thereof; the limiting blocks engage with the limiting grooves respectively.
